(19) United States
(12) Patent Application Publication
(10) Pub. No.: US 2019/0135047 A1
(43) Pub. Date: May 9, 2019

(54) PNEUMATIC TIRE

(71) Applicant: TOYO TIRE & RUBBER CO., LTD., Itami-shi (JP)

(72) Inventor: Toshikazu Yasunaga, Itami-shi (JP)

(73) Assignee: TOYO TIRE & RUBBER CO., LTD., Itami-shi (JP)

(21) Appl. No.: 16/167,843

(22) Filed: Oct. 23, 2018

(30) Foreign Application Priority Data
Nov. 8, 2017 (JP) 2017-215877

(51) Int. Cl. B60C 11/16; B60C 11/03; B60C 11/11; B60C 11/12

(52) U.S. Cl. CPC B60C 11/1693; B60C 11/1625; B60C 11/0309; B60C 2011/1213; B60C 11/1204; B60C 2011/0358; B60C 11/11

(57) ABSTRACT

A tread portion has a pin hole with a stud pin being mounted. In the periphery of the pin hole a recess is formed that gradually deepens as the recess extends toward radially outside and that has a depth of 10% or less of the depth of the pin hole.

### CROSS-REFERENCE TO RELATED APPLICATIONS

This application claims priority based on Japanese Patent Application No. 2017-215877 filed on Nov. 8, 2017, the contents of which are incorporated herein by this reference.

### BACKGROUND OF THE INVENTION

### Technical Field

The present invention relates to a pneumatic tire.

### Related Art

Conventionally, a pneumatic tire has been known in which a plurality of recessed parts extending in the outer diameter direction are formed in the periphery of each pin hole with a stud pin being mounted (for example, see Japanese Patent No. 5452588).

However, in the conventional pneumatic tire, a recessed part having substantially the same depth as the pin hole is arranged near the pin, and the holding strength of the pin hole with respect to the stud pin is not sufficient.

### SUMMARY

An object of the present invention is to provide a pneumatic tire capable of ensuring an anti-detachment property of a stud pin and improving ice performance.

The present invention provides, as a means for solving the above problem, a pneumatic tire including a tread portion having a pin hole with a stud pin being mounted, in which in a periphery of the pin hole a recess is formed that gradually deepens as the recess extends toward radially outside and that has a depth of 10% or less of a depth of the pin hole.

With this configuration, the recess formed in the periphery of the pin hole does not adversely affect the holding strength of the pin hole with respect to the stud pin. Moreover, an edge formed by the recess acts so as to bite into an ice and snow surface. Accordingly, excellent ice performance is exerted by the stud pin firmly held and an edge effect of the recess.

It is preferable that the recess is one of a plurality of recesses.

With this configuration, the number of edges formed by the recesses increases, and further excellent ice performance can be exerted.

It is preferable that the recesses are arranged evenly in a circumferential direction around the pin hole.

With this configuration, an edge effect can be obtained in any direction around the stud pin, thus exhibiting excellent ice performance not only, for example, during straight running but also during turning.

It is preferable that the recesses increase in width from a center of the pin hole toward radially outside.

With this configuration, an edge length can be increased on an outer diameter side of the pin hole, where a holding state of the stud pin is hardly affected. This makes it possible to exert further excellent ice performance.

According to the present invention, in the periphery of a pin hole a recess is formed that gradually deepens as the recess extends toward radially outside and that has a depth of 109 or less of a depth of the pin hole, so that it is possible to improve ice performance while maintaining a good holding state of the pin hole with respect to the stud pin.

### BRIEF DESCRIPTION OF THE DRAWINGS

The foregoing and the other feature of the present invention will become apparent from the following description and drawings of an illustrative embodiment of the invention in which:

FIG. 1 is a partial development, view of a tread portion of a pneumatic tire according to the present embodiment;

FIG. 2 is a plan view showing a pin region in FIG. 1; and

FIG. 3 is a sectional view of a recessed portion of the pin region in FIG. 2.

### DETAILED DESCRIPTION OF EMBODIMENTS

An embodiment of the present invention will be described bel with reference to the accompanying drawings. It should be noted that the following description is merely exemplary in nature and is not intended to limit the invention, its applicable objects, and its applications.

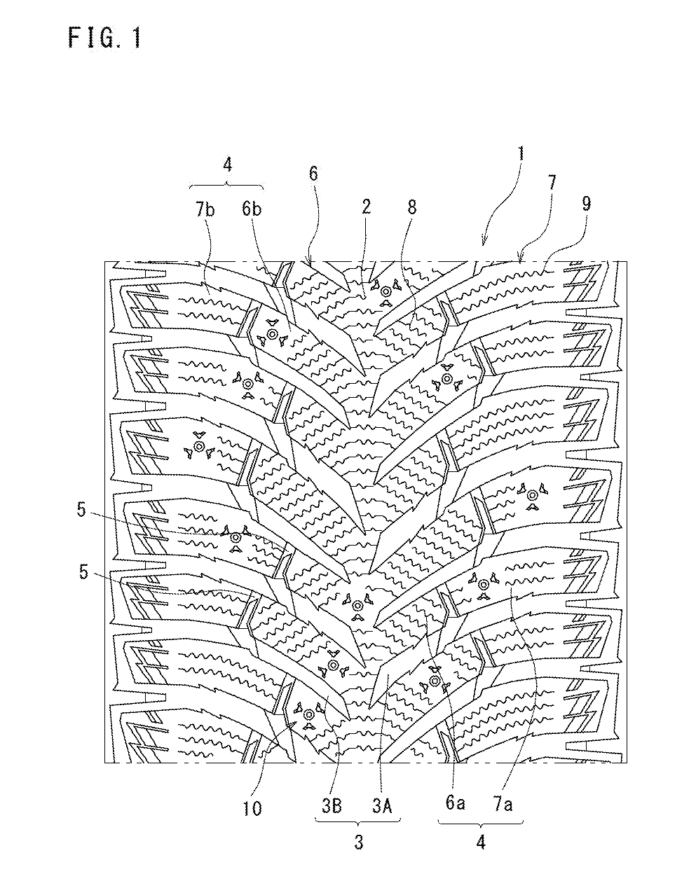

FIG. 1 is a partial development view of a tread portion 1 of a pneumatic tire according to the present embodiment. A center rib 2 is formed at the center in the tire width direction of the tread portion 1. On both sides of the center rib 2 in the tire width direction, inclined blocks 4 defined by inclined grooves 3 extend. As a result, the inclined blocks 4 are arranged at predetermined intervals in the tire circumferential direction.

The inclined groove 3 includes a wide first inclined groove 3A and a narrow second inclined groove 3B. Portions of both side edges of the first inclined groove 3A are formed in a zigzag shape.

Longitudinal grooves communicating substantially orthogonally with the first inclined groove 3A and the second inclined groove 3B on both sides midway in the inclined blocks 4 are formed. The longitudinal grooves 5 are alternately displaced between the inclined blocks 4 arranged in the tire circumferential direction on the center side and the lateral sides in the tire width direction. As a result, the inclined block 4 is separated into a center block 6 and a shoulder block 7. The center block 6 includes a short first center block 6a and a long second center block 6b. The shoulder block 7 includes a long first shoulder block 7a following the first center block 6a and a short second shoulder block 7b following the second center block 6b.

In the center rib 2 and the center block 6 following the center rib 2, first sipes 8 are formed radially around the center rib 2 side. Two or three second sipes 9 are formed in the shoulder block 7 along the longitudinal direction of the shoulder block. The sipes 8 and 9 each have a waveform. One end of the first sipe 8 communicates with the inclined groove 3, and the other end of the first sipe 8 terminates in the center rib 2 or the center block 6. One end of the second sipe 9 communicates with the longitudinal groove 5, and the other end of the second sipe 9 terminates in the shoulder block 7. However, a pin region 10 is formed in each of the blocks 6 and 7 as described later, and the sipes 8 and 9 are not formed in this pin region 10.

The pin regions 10 are formed in the center rib 2, the center blocks 6 and the shoulder blocks 7. The pin regions 10 are respectively formed on the center rib 2, the end portion of the first center block 6a which is located on the tire width direction side, the center portion of the second center block 6b, the end portion of the second center block 6b which is located on the tire width direction side, the center side of the first shoulder block 7a, and the center portion of the second shoulder block 7b. This is because when the tread portion 1 is divided into the center region along the center rib 2, the mediate regions on both sides of the center region, and the shoulder region on the outer side in the tire width direction, the number of pin regions 10 is substantially even in each region. Further, the pin regions 10 are arranged so as to be substantially even in the tire circumferential direction.

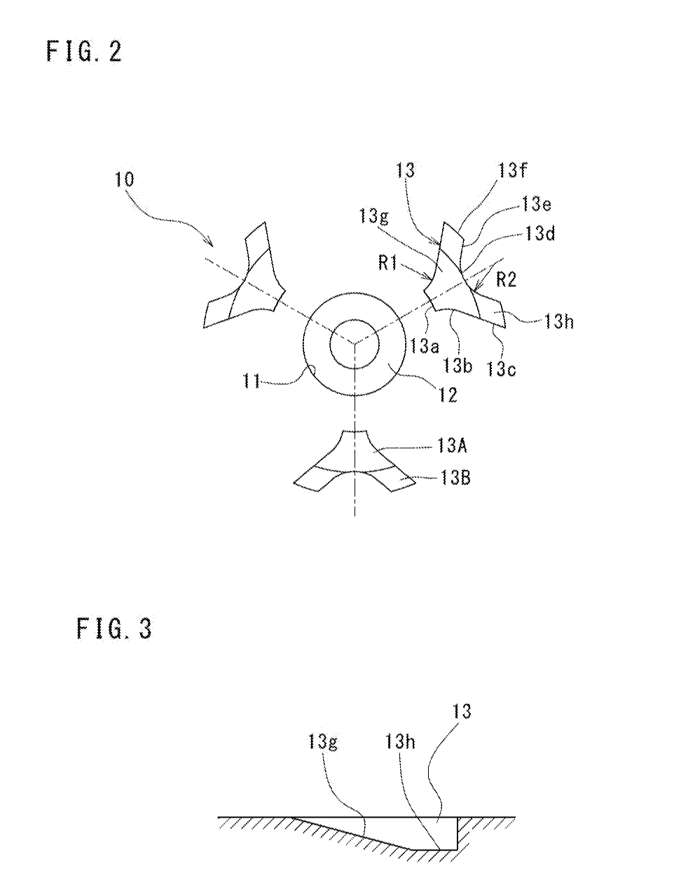

As shown in FIG. 2, a pin hole 11 is formed in the center portion of each pin region 10, and a stud pin 12 is mounted in the pin hole. Three recesses 13 are formed at equal angular intervals in the periphery of each pin hole 11. Each of the recesses 13 extends so as to gradually increase in width toward radially outside around the pin hole 11. An inner edge 13a of the recess 13 is formed concentrically with the pin hole 11, and both side edges include an inner arcuated edge 13b which increases the width of the recess 13 with a radius R1, and a linear outer edge 13c extending further radially outside. The outer edge of the recess 13 includes an outer arcuated edge 13d with a radius R2, an inner edge 13e extending parallel to both side edges from the outer arcuated edge 13d, and an outermost edge 13f located outermost in radial direction. The bottom surface of the recess 13 includes an inclined surface 13g gradually deepens from the inner edge to the concentric circle contacting the outer arcuated edge 13d on radially outside and a flat surface 13h surrounded by the outer edge 13c, the inner edge 13e, and the outermost edge 13f and having the same depth. The depth of the deepest flat surface of the recess 13 is set to 10% or less this case, 0.8 mm) of the depth of the pin hole 11. Note that a region where the inclined surface 13g is formed gives a fan-shaped portion 13A of the recess 13 and a region where the flat surface 13h is formed gives a branch portion 13B of the recess 13.

The pneumatic tire with the pin regions 10 each having the above configuration has the following advantages.

(1) The recess 13 formed in the periphery of the stud pin 12 is 10% or less of the depth of the pin hole 11, so that even if the ground contact pressure acts, the holding strength of the pin hole 11 with respect to the stud pin 12 is not reduced. In particular, since the recess 13 is formed so as to gradually decrease in depth toward the center of the pin hole 11, the holding strength of the pin hole 11 can be further increased.

(2) The recess 13 increases in width toward radially outside with respect to the center of the pin hole 11 and the distal end portion of the recess 13 is bifurcated, so that the length of the edge to be formed can be increased. Therefore, a scratching effect (edge effect) is obtained When the tire contacts the ice and snow surface.

Note that the present invention is not limited to the configuration described in the above embodiment, and various modifications can be made.

In the above embodiment, the number of recesses 13 for one pin region 10 is three, but the number is not limited to this and can be set to one, two, or four or more.

In the above embodiment, the recess 13 has two branch portions 13B, but the branch portion 13B may be three or more.

What is claimed is:

1. A pneumatic tire comprising a tread portion having a pin hole with a stud pin being mounted,
wherein in a periphery of the pin hole a recess is formed that gradually deepens as the recess extends toward radially outside and that has a depth of 10% or less of a depth of the pin hole.

2. The pneumatic tire according to claim 1, wherein the recess is one of a plurality of recesses.

3. The pneumatic tire according to claim 2, wherein the recesses are arranged evenly in a circumferential direction around the pin hole.

4. The pneumatic tire according to claim 1, wherein the recesses increase in width from a center of the pin hole toward radially outside.

5. The pneumatic tire according to claim 2, wherein the recesses increase m width from a center of the pin hole toward radially outside.

6. The pneumatic tire according to claim 3, wherein the recesses increase in width from a center of the pin hole toward radial outside.
